(19) United States
(12) Patent Application Publication
(10) Pub. No.: US 2008/0070580 A1
(43) Pub. Date: Mar. 20, 2008

(54) METHOD AND APPARATUS FOR CONFIGURING EQUIPMENT IN A COMMUNICATION NETWORK

(75) Inventors: Barry J. Menich, South Barrington, IL (US); Rod N. Averbuch, Buffalo Grove, IL (US); Mark A. Gannon, Sleepy Hollow, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/531,753

(22) Filed: Sep. 14, 2006

(51) Int. Cl. H04Q 7/20

(52) U.S. Cl. 455/446

(57) ABSTRACT

A base station 106 is provided that has a transceiver 202 that transmits and receives data. The transceiver is coupled to a controller 204. To configure the base station, the transceiver sends an identifier 210 that is associated with the base station together with information regarding the installation of the base station in the communication to the network to access parameters 306 from a database 304 for the base station. The parameters can be based on data known from the purchase of the base station, the location of the base station within the communication network and planning data for the communication network.

### FIELD OF THE INVENTION

The present invention relates generally to configuring equipment in a communication network and, in particular, to configuring a base station during the installation process.

### BACKGROUND

Wireless communication networks, such as Code Division Multiple Access (CDMA), W-CDMA, CDMA2000, Global System of Mobile Communications (GSM) Universal Mobile Telecommunication System (UMTS) systems and others, include many base stations. Each of the base stations provides coverage for a limited area, known as a cell, within the network such that mobile stations that operate within the area of the cell receive signals from the base station. As network conditions change and the number of mobile stations operating within a cell changes, wireless communication network operators may modify the number of base stations used within a region of a network by installing new base stations in strategic locations within the network. As the number of base stations changes, the size of cells changes with the goal of improving network performance for the users of the mobile stations.

The installation of base stations within a network is a detailed process. After a base station manufacturer completes manufacturing the base station, it can be delivered to the network operator for later installation or it can be delivered directly to the point of installation. When a location is determined for a new base station, the manufacturer or operator delivers the base station equipment to the location for installation. A technician then completes assembly and provides initiation processes for the base station software. The technician can initialize parameters necessary for the base station to operate. Such parameters include the location of the base station, information regarding neighboring base stations, signaling information and the like. In addition, the technician can install optimization parameters into the base station based on information provided. As can be appreciated, the installation of a base station can be a time consuming process and a considerable amount of information is needed to be installed into the base station that is particular to its location and environment that makes it necessary to provide the information on site during the installation process.

Base station suppliers can provide some of the information necessary to optimize the base station during the manufacturing process. In order to do so, however, the supplier needs to have the information before the base station is delivered to the network operator. Operators, however, are not always able to provide all the information necessary to install and optimize the base station because the final location of the base station is not known. Operators may prefer that base station be delivered to one location with a standard configuration for later delivery to particular locations within the network on an as needed basis. In this case, optimization is done during the installation process and requires more significant participation by the technician.

To assist the technician, base stations can be provided with sensors and programs that acquire data regarding the network and the location of base station's installation. These sensors and programs are used to collect data about the network by the newly installed base station and then used by that base station as a part of the installation process. In addition, operators can provide certain data to the base station before installation at a particular location thereby reducing the time and effort needed by the technician to install the base station.

Base station manufacturers also have data that can be used by the base station for optimization. This data is often provided to the base station during the manufacturing process. The manufacturer may also have other optimization data that can be provided once the location of the new base station within the communication network is known. Such parameters may relate to how the new base station operates with other types of base stations. It may be difficult for the manufacturer to manufacture the base station with such data before the delivery because the final location of the base station is not known by either the base station manufacturer or the network operator prior to delivery of the base station. Such information can be provided during final installation. But circumstances may exist, including the increased cost and the nature of the information, which makes it difficult to complete installation of the base station with all the data necessary to optimize its parameters.

Accordingly, a need exists to provide for a more efficient method of installing base stations and other network equipment where optimization data can be provided by more than one source such as both a base station manufacturer and a network operator. A need also exists for equipment manufacturers to be able to provide installation data to the equipment after the delivery of the equipment and during the equipment's installation.

### BRIEF DESCRIPTION OF THE FIGURES

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is an example wireless communication network illustrating a new base station being installed into the network in accordance with some embodiments of the invention.

FIG. 2 is a block diagram of the wireless communication operating in accordance with the principles of the present invention.

FIG. 3 is a block diagram of a base station configured in accordance with the principles of the present invention.

FIG. 4 is a flow chart of the installation of a base station into a wireless communication network in accordance with some embodiments of the present invention.

FIG. 5 is a flow chart of the installation of a base station into a wireless communication network in accordance with another embodiment of the present invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of method steps and apparatus components related to configuring a piece of equipment, such as a base station, as it is being installed into the infrastructure of a wireless communication network. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

It will be appreciated that embodiments of the invention described herein may be comprised of one or more conventional processors and unique stored program instructions that control the one or more processors to implement, in conjunction with certain non-processor circuits, some, most, or all of the functions of configuring a piece of equipment, such as a base station, as it is being installed into a wireless communication network as described herein. The non-processor circuits may include, but are not limited to, a radio receiver, a radio transmitter, signal drivers, clock circuits, power source circuits, and user input devices. As such, these functions may be interpreted as steps of a method to perform the configuration of the piece of equipment during its installation into the network. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The present invention provides a method for installing and configuring a piece of equipment, such as a base station, such that the piece of equipment is optimized for operation within a communication network. The piece of equipment is provided with an identifier that can be used by the network operator or the equipment manufacturer to optimize the parameters of the equipment within the communication network. A location is selected and then a technician proceeds to install the piece of equipment at the location. During the installation process, the technician or the piece of equipment determines information for operation of the equipment based on the installing of the piece of equipment in the communication network. During installation, parameters are accessed form a remote location based on the determined information and the identifier. The parameters may be maintained by the equipment manufacturer. The piece of equipment is then optimized based on the parameters. In an embodiment, the piece of equipment is a base station that is being deployed within the network. The parameters that are obtained can be data known by the equipment manufacturer from purchase of the equipment by the operator, the location of the equipment in the communication network and previous planning data for the communication network. The piece of equipment can be configured with sensors that obtain information from other equipment within the network and this information can be provided to obtain the parameters used to optimize the piece of equipment.

In an alternative embodiment of the present invention, a base station is provided that has a transceiver that transmits and receives data. The transceiver is coupled to a controller. The controller is capable of configuring the base station while the base station is being installed within a communication network, such as a wireless communication network. To configure the base station, the transceiver sends an identifier that is associated with the base station together with information regarding the installation of the base station in the communication to the network to access parameters for the base station. The parameters include data that is known about optimizing the base station prior to the installation with the communication network. The parameters can be based on data known from the purchase of the base station, the location of the base station within the communication network and planning data for the communication network. The controller can be configured to operate the transceiver to send data regarding the optimization of the base station within the communication network to other base stations within the network. In addition, the parameters can be accessed from a database that is remote from the base station and can be a part of the communication network or separate from the communication network.

In yet another embodiment of the present invention, a wireless communication network is provided that includes a base station having an identifier which is provided to the base station during manufacture of the base station and a database that is remote from the base station wherein the database includes parameters for installation of the base station within the wireless communication network. The parameters are known prior to the installation of the base station. During installation of the base station within the wireless communication network, the base station provides an identifier associated with the base station prior to installation together with data regarding the installation of the base station within the wireless communication network to access the parameters from the remote data base. The accessed parameters are used by the base station to optimize the configuration of the base station within the wireless communication network.

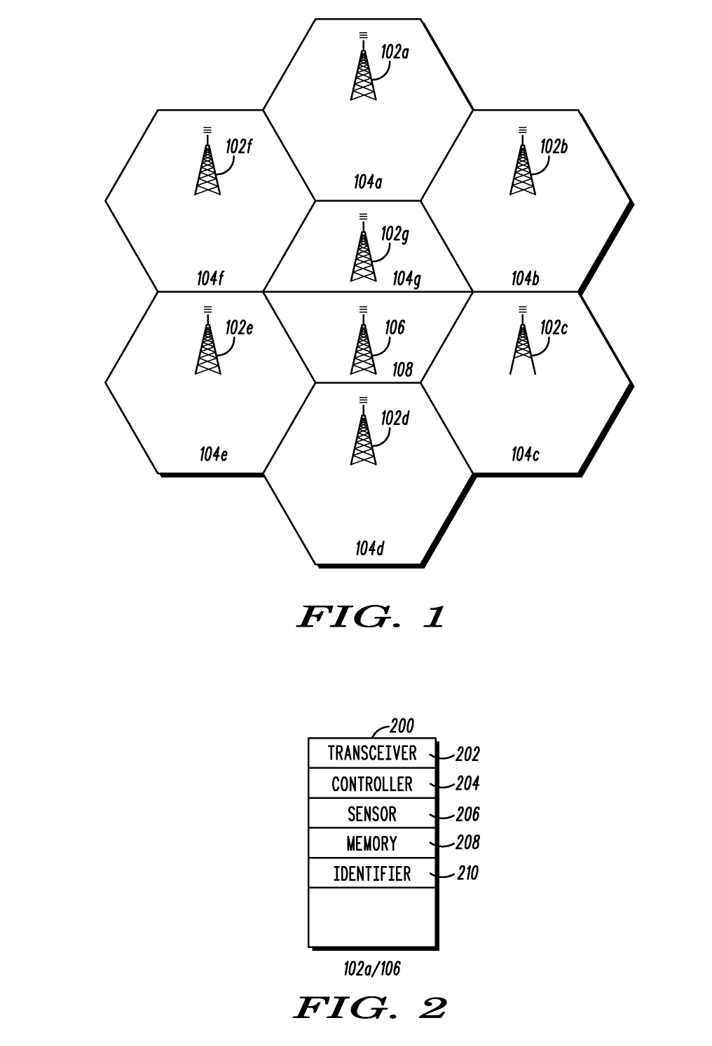

Turning to FIG. 1, a communication network 100 is provided where the communication network can be a wireless communication network that uses any known wireless protocol such as CDMA, GSM, UTMS or other 2G, 3G or 4G technology. An integral part of the communication network is base stations 102a-g. Base stations 102a-g send and receive signals to and from one another and to and from mobile stations (not shown) that operate within the communication network 100. The signals that are sent and received by each of the base stations 102a-g have a given range that creates a cell 104a-g within the communication network 100 associated with each base station.

Network operators select where to locate base stations 102a-g within the network 100 based on many different criteria including but not limited to usage by mobile station and geography. While FIG. 1 shows that cells 104a-g have the same general shape and coverage area or range, it can be appreciated that usage and geography may require that cells can be of different shapes and configurations such that the base stations 102a-g have different ranges. For example, a city where there are lots of buildings may require base stations 102a-g to be in close proximity with one another while base stations located in the country where there are not many obstructions between base stations can have the base stations 102a-g relatively far apart.

The arrangement of base stations 102a-g in the network 100 may need to be modified over time based on changing conditions. For example, increased communication traffic in a given area can cause a given base station to have difficulty in maintaining all the required connections for the mobile stations that are found in the corresponding cell. New buildings within a cell may change the topography for the cell such that the original base station cannot properly provide the service to the mobile stations found in the cell. Other system and network conditions can also exist that cause a network operator to need to add, move or reconfigure base stations 102a-g within the network 100.

In view of the foregoing, a network operator may determine that a new base station 106 is required in the network 100. A suitable location is therefore found depending on the current configuration and the needs of the network. As seen in FIG. 1, it is determined that a new base station 106 is needed in cell 104g that therefore divides cell 104g into two cells 104g and cell 108. Additional base stations can be added to expand the coverage area of the network 100 such that the new cell can be added to the edges of the network 100.

FIG. 2 illustrates a block diagram of base stations 102a-g, 106 where those elements that are relevant to the present invention are shown and other known elements which are known to be a part of the base station but not needed for the understanding of the present invention are not shown. Base stations 102a-g, 106 include a transceiver 202 that transmit and receive signals between a base station and other base stations 102a-g, 106 within the network as well as mobile stations and other network equipment (not shown). The base station also includes a controller 204 that is coupled to the transceiver as well as other elements within base station such that it controls the operation of the base station according to various specifications. The specifications can be provided to the base station during the manufacture, installation and later optimization of the base station according to the principles of the present invention.

In addition, base station 102a-g, 106 can include at least one sensor 206 that is arranged to obtain data regarding the network and from other base stations. The sensor detects network information and data during installation and operation of the base station in the network 100. Information obtained by the sensor 206 can be stored in memory 208 together with other data and parameters used by the controller for the installation, optimization and operation of the base station.

During the manufacturing of the base station 102a-g, 106, an identifier 210 can be associated in with the base station. The identifier is a unique number or other identification that can be used to distinguish one base station from the other base stations manufactured by a particular base station manufacturer. In an embodiment, the identifier can be stored in the memory 208. As will be understood from the description provided, the identifier may be used by the base station to access parameters that are known by the base station's manufacturer and that are for optimizing the base station within the network. In addition, the identifier can be associated with other data regarding the base station. Some of this data may be obtained during the installation of the base station and can be used for optimization.

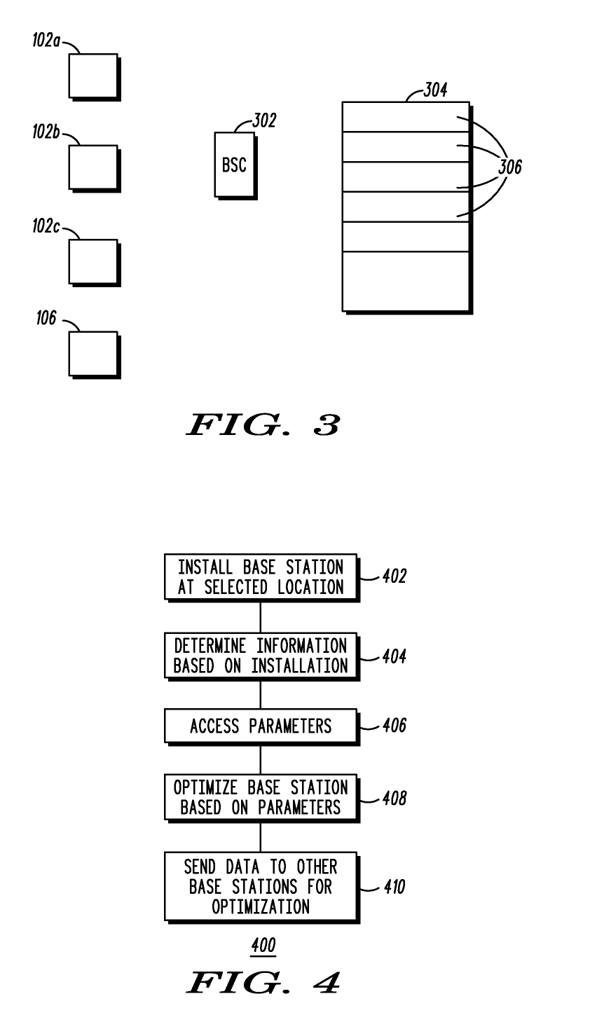

FIG. 3 illustrates an alternative view of the network 100 including base stations 102a-g and base station 106. The base stations, and in particular base station 106 which is new to the network, are each provided with the unique identifier 210. As shown, the base stations 102a-g and 106 are connected to a base station controller 302. The connection between the base stations and the base station controller 302 can be a wired or wireless connection depending on network configurations. Base station controller 302 is of a type known in the art and provides the necessary capability of controlling the functions and operations of the various base stations. A network 100 can have more than one base station controller 302 such that each controller 302 connects to different base stations within the network and multiple base station controllers are coupled together so that the operation of the controllers can be co-ordinated. In addition, pieces of equipment (not shown) other than the base station controller 302, which are known in the art, are used by a network operator to operate and control the network. These other pieces of equipment can be distributed throughout the network or can be housed at a central location maintained by the operator.

In an embodiment of the invention, a database 304 is accessible by the network 100 and by way of the base station controller 302, but as can be appreciated other pieces of equipment in the network 100 can access the database 304. The database 304 is remote from the network and in an embodiment is populated by and maintained by the manufacturer of base stations 102a-g, 106. The manufacturer populates the database with parameters 306 that can be used by the operator to optimize the base station 106 when it is being installed into network 100. In an embodiment, these parameters 306 are not generally known or accessible by the network operator. In addition, these parameters may not be able to be loaded onto the base station until the base station is being installed or after the base station is installed into the network. The parameters 306 can be of numerous different sources and the manufacturer may not be able include as part of a delivered product because not all the information is known at the time the base station 106 is delivered. The parameters can be known by the base station manufacturer from data known from the purchase of the base station, from the location of the base station within the network or from previous planning data for the communication network. In addition, the parameters can relate to how a given base station 106 operates with other base stations manufactured by the same or other manufacturers.

In an embodiment, the database 304 is arranged so that different parameters can be provided for different base stations made by the manufacturer. In this arrangement, parameters that are required for a specific base station can be associated by way of a keying system where the parameters are accessible by the identifier 210. Other parameters can be provided that are universal for all base stations 102a-g, 106 are particular for a group of base stations. These parameters can also be accessible by use of the identifier 210. In an embodiment, the parameters can be organized in the database in a relational manner such cells can be linked in a cluster for common optimization purposes.

For example, certain parameters that are needed for installation and operation are obtained from the location of base station 106 within the network 100 and its relationship with other base stations 102a-g that are already in the network. The base station 106 may need this information about other base stations 102a-g in order to be able to optimize its configuration within the network 100. This network information can be obtained by using the sensors 306 on the base stations. Other parameters are known by the manufacturer when the base station 106 is ordered by the operator. As can be appreciated, some of these parameters can not be optimized until other parameters are known, which may not be known by the manufacturer until later in the installation process and can be dependent on network information obtained by the sensors 206.

As stated, the base station 106 is provided with various data, information and parameters during installation for optimization of the base station within the network 100 in accordance with the principles of the present invention. Such data, information and parameters include frequency plans, neighbor lists that provide data regarding other base stations and other equipment within the network, transmit power limitations, geographic information such as distances to neighboring cells 104a-g. [Are there other relevant parameters]

FIG. 4 is a flow chart is an embodiment of the process 400 that base station 106 goes through while using the unique identifier to optimize the installation and performance of the base station within the network. The process begins with the technician installing 402 the base station at a location chosen for the new base station 106. The location can be chosen based on a number of different criteria and that can depend upon, at least in part, the conditions of network 100 and the usage patterns of the mobile stations that use the network 100. As a part of the installation process, the base station 106 determines 404 information for its operation from installing the base station within the network 100. This information can be related to the location of the base station in the network, information regarding other base stations 102a-g such as neighboring base stations and other related information. In addition, this information can include data regarding the optimization of the base station that is obtained during the installation process which can be used as a part of a feedback mechanism for the optimization process.

This information can be determined by being provided by the technician or by the base station receiving signals from the other base stations and other pieces of equipment within the network such as base station controller 302. In an embodiment of the present information, the sensors 306 provided with the base station 106 are used to obtain information and data regarding other base stations 102a-g or other network equipment. The sensors receive signals from the other base stations 102a-g regarding the operation of the base stations within the network that can be used by base station 106 for performance and optimization within the network 100. The sensors can measure downlink performance for all the cells 104a-g and base stations 102a-g that surround base station 106 as well as decode control channel information. When the new base station 106 connects to the database 304 in accordance with the principles of the present invention, the location is determined and location-based sensor information is retrieved. Channel information and code sets can therefore be assigned.

As is understood from the description above, additional parameters can be used to optimize the performance of the base station 106. Thus, the parameters that are in the database 304 are accessed 406 by the base station. The correct parameters are accessed from the database by providing the database with at least the identifier associated with the base station 106. The database can be on an engine or server that checks the unique identifier 210 against a database of subscriber systems. Where the base station is not found on the database, a token is returned to the base station 106 indicating that that no optimization parameters are available and standard parameters can be provided.

Other parameters can be accessed for use by the base station by providing information received by the base station during the installation process. For example, the identifier and the geographical location of the base station can be provided to the database such that optimization parameters that are known regarding the base station's particular model and how that model will perform with respect to the geographic location or the how it will perform with neighboring base stations 102a-g that may be base station models that are manufactured by the same or different manufacturers. The optimization parameters can be developed by a base station manufacturer form information and data provided during the ordering and purchase process of the base station 106 but cannot be included as a part of the base station until it is in the network 100. In addition, the identifier and the determined information can be used to access parameters 306 in the database 304 that are known to the manufacturer from known planning materials about the network. These planning materials provide information regarding the network and performance criteria. In addition, these planning materials can relate to the manufacturers knowledge of the base station performance capabilities in certain situations based on network activities and locations.

Once the base station has obtained the parameters from the database, the base station can be optimized 408 for performance within the network 100 as the parameters are specific for the base station and for its location within the network.

As stated, the unique identifier 210 can also contain location information. In an embodiment, the information is used, in conjunction with information regarding already established base stations 102a-g and cells 104a-g to simulate the effect of incorporating a new base station 106 and cell 108 in the network 100. The location information allows the optimization through parameters 306 in the database 304 to determine what cells are adjacent, their transmit information and neighbor lists, and transmit location from which to calculate transmission loss using available terrain and topographic data. Based on the outcome of these simulations, configuration data is then sent to new base station 106 as well as nearby cells and base stations that may be affected by the installation and commissioning of new base stations 106.

In an embodiment, the process 400 continues by the base station 106 sending 410 data regarding its optimization to other base stations 102a-g. This can be done using base station controllers 302. An additional base station 106 within the network can affect the performance of the other base stations 102a-g within the network. By sending 410 the data regarding the optimization of base station 106 to other base stations, the performance of the network can also be optimized.

The new base station 106 can access the parameters 306 from database 304 in a variety of ways. In one embodiment, the base station can subscribe to a service where the parameters are provided by a central server, which maintains the database 304. The server can be within the network and maintained by the network operator or the base station manufacturer. When the base station 106 is installed into the network 100, the parameters are provided to the base station based on what the server knows about the network and where the base station 106 is located. Additional information known by the server regarding other base station 102a-g within the network can also be supplied to the base station 106. In an embodiment, the base station 106 can subscribe to a service in which it obtains parameters from the server and database during installation and at times subsequent to installation. The updated parameters are supplied to the database by the base station manufacturer and are based on data and information known by the manufacturer through the purchase of equipment by the network operator, network parameters and updates to the performance of the base station.

In another embodiment, the base station is programmed to configure itself on its own during installation. Accordingly, the base station 106 uses the identifier 210 together with information gleaned during the installation to obtain the parameters. The base station then engages in self optimization. The information can be obtained using sensors or from the base station controller 302. The self optimization is achieved using the parameters supplied from the database as well as data and options supplied with the base station during manufacture.

The base station 106 can be equipped with additional hardware and software (not shown) that allows for at least some form of self-optimization such as downlink radio receivers that allow the base station to measure downlink signals for other bases stations 102a-g. An algorithm in new base station 106 cycles through the list of RF carriers within the spectrum of the desired service and creates a list of the RF carriers rank ordered by signal strength. Starting with the bottom of the list, the base station then assigns RF carriers to itself This ensures the minimum amount of interference with surrounding cells 104a-g. In the case where the wireless service is based on DS-CDMA, the code space is searched for nearby cells in a similar fashion. Proceeding form the top of the rank ordered list, the new base station 106 attempts to demodulate the control channel information to determine the identities of the surrounding cells. The demodulated information is associated with the identities in the rank offered list and a handoff neighbor list is constructed using the same rank ordering. Based upon the previous search and knowledge of the demodulated control channel information, the new base station 106 selects a PN code in accordance with codes already in use as well as the PN index offset currently in use in the immediate region.

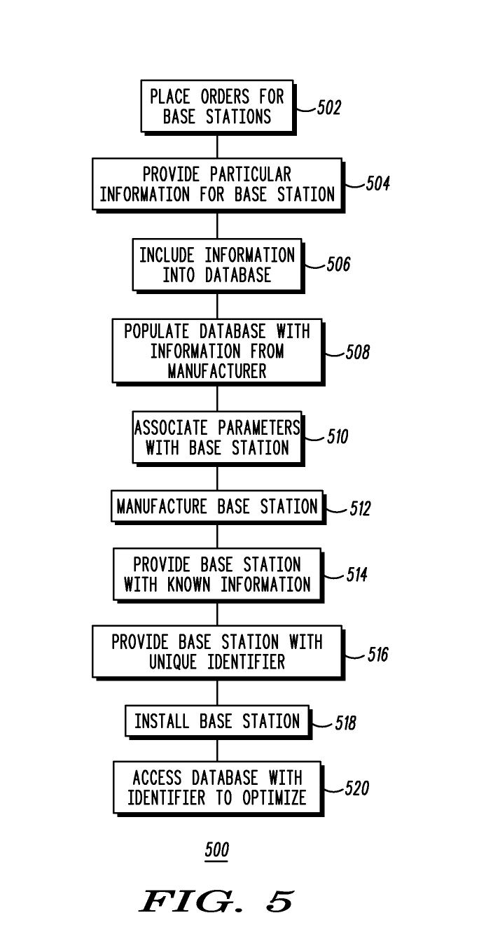

FIG. 5 is a flow chart showing the optimization 500 of a base station 106, or other equipment, within a communication network 100. A network operator can place orders 502 using standard business procedures at various times such as on an as needed basis when a base station is needed or by ordering numerous base stations for later deployment within the network 100. When ordering a base station on an as needed basis, the network operator can provide 504 particular information regarding the base station including but not limited to the location of the base station within the network. When base stations are ordered for later deployment, the network operator can still provide some details about the intended use of the base station within the network, but not all the necessary information can be supplied.

The information provided by the operator can be included 506 into database 304. The manufacturer can also take the information provided by the network operator from the purchase of the base station and populate 508 the database with parameters that are understood by the manufacturer. Additional information regarding how a base station operates within a network that is known by the manufacturer can be included in the database. The parameters in the database can be associated 510 with a given base station in any number of ways such that various parameters are acquired from the database depending on the data provided.

A manufacturer will manufacture 512 a base station 106 to fulfill orders based on the business relationship with and requirements of the network operator. Based on the order provided to the base station manufacturer, each base station is provided 514 with certain information, data and parameters that are known to be specific for that base station at the time manufacture. In addition, the manufacturer supplies 516 each base station with a unique identifier 210 to distinguish the new base station from other base stations.

At least one technician, who can be employed by a network operator, performs different steps install 518 a new base station 106 in the location chosen by the network operator. In one embodiment, the technician installs a base station that was specifically manufactured for the location at which it is being placed. In another embodiment, the technician installs base station 106 that is selected for a group of base stations that have been delivered to the network operator by a manufacturer. Regardless of the type of base station 106 being installed, the technician proceeds through the necessary steps to physically place the base station at its location and then proceeds through the necessary steps to install and initiate the software that is used by the base station at its location. As a part of the present invention, the technician causes 520 the base station 106 to access the database 304 using the unique identifier 210 to access the parameters that can be used to optimize the performance of the base station 106 within the network 100.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

We claim:

1. A method of installing equipment in a communication network, the method comprising:
installing the equipment in the communication network, wherein the piece of equipment includes an identifier;
determining information for operation of the equipment based on installing the piece of equipment in the communication network;
accessing parameters for the equipment based on the information and the identifier, and
optimizing the equipment for operation within the communication network based on the accessed parameters.

2. The method of claim 1 wherein the equipment is a base station within a wireless communication system.

3. The method of claim 1 wherein the parameters are based on one of data known from purchase of the equipment, location of the equipment in the communication network and previous planning data for the communication network.

4. The method of claim 1 wherein determining information for operation of the equipment comprises sensing information for the operation of the equipment from the location the equipment is installed.

5. The method of claim 1 further comprising sending data regarding the optimization of the equipment to other pieces of equipment within the communication network.

6. The method of claim 1 wherein accessing parameters comprising accessing a remote database having data regarding the optimization of equipment within a communication network.

7. The method of claim 1 wherein the identifier includes data for optimization of the equipment.

8. A base station comprising:
a transceiver for transmitting and receiving data within a communication network;
a controller coupled to the transceiver wherein the controller configures of the base station during installation of the base station within a communication network by operating with the transceiver to send an identifier associated with the base station together with information regarding the installation of the base station in the communication network to access parameters for the base station that is based on the identifier and the information and wherein the parameters include data known about the optimizing the base station prior to installation within the communication network.

9. The base station of claim 8 further comprising a sensor to acquire the information regarding the installation of the base station within the communication network.

10. The base station of claim 8 wherein the parameters are based on one of data known from purchase of the base station, location of the base station in the communication network and previous planning data for the communication network.

11. The base station of claim 8 wherein the controller further configured to operate with the transceiver to send data regarding the optimization of the base station within the communication network to other base stations within the communication network.

12. The base station of claim 8 wherein the parameters are stored in a database remote to where the base station is installed.

13. The base station of claim 8 wherein the identifier includes information for the optimization of the base station.

14. A wireless communication network comprising:
a base station having an identifier provided during manufacture of the base station, and
a database remote from the base station, wherein the database includes parameters for the installation of base stations within the wireless communication network and wherein the parameters are known prior to the installation of base station,
wherein during installation of the base station in the wireless communication network the base station provides the identifier and data regarding the installation of the base station to the remote database to acquire parameters to be used by the base station to optimize the configuration of the base station within the wireless communication network.

15. The wireless communication network of claim 14 wherein the parameters are based on one of data known from purchase of the equipment, location of the equipment in the communication network and previous planning data for the communication network.

16. The wireless communication network of claim 14 wherein the base station comprising a sensor to acquire data regarding the location of the base station within the communication network wherein the data is sent with the identifier to access the parameters.

17. The wireless communication network of claim 14 wherein the base station sends data regarding the optimization of the base station to other base stations within the communication network.

18. The wireless communication network of claim 14 wherein the identifier includes information for the optimization of the base station.
